(19) United States
(12) Patent Application Publication
(10) Pub. No.: US 2021/0365645 A1
(43) Pub. Date: Nov. 25, 2021

(54) SOCIAL SAFE METHOD AND SYSTEM OF LANGUAGE TRANSLATION

(71) Applicant: Zhaoyang Li, San Jose, CA (US)

(72) Inventor: Zhaoyang Li, San Jose, CA (US)

(21) Appl. No.: 17/010,225

(22) Filed: Sep. 2, 2020

Related U.S. Application Data
(60) Provisional application No. 63/027,355, filed on May 20, 2020.

(51) Int. Cl. G06F 40/58

(52) U.S. Cl. CPC G06F 40/58

(57) ABSTRACT

The present invention provides a social safe method of language translation, a device having a software program therefor, and a system comprising a having the software program.

### CROSS-REFERENCE TO RELATED APPLICATION

The present application claims the benefit of U.S. provisional application No. 63/027,355, filed May 20, 2020, the teaching of which is incorporated herein in its entirety by reference.

### FIELD OF THE INVENTION

The present invention relates to social safe methods and system for language translation, which is advantageous in the field of telemedicine, particularly in medical practice, on e.g., a COVID-19 disease.

### BACKGROUND OF THE INVENTION

Accurate language translation is a need in every aspect of human life in the era of globalization and international integration of social life, economic, political and science and technology. In the era of pandemic, social distancing becomes a norm. When translation is needed, machine translation would be highly desirable. This is especially true in the field of medicine—as telemedicine becomes more and more of a necessity, machine translation is sometimes the only available means of translation. The need for an accurate digital method of translation is becoming a more pressing issue due to COVID-19 pandemic.

The current technology of language translation such as Google Translate has been more and more common. However, the current translation technology does not provide an accuracy of translation that makes the translation a reliable tool translation. As of today, the art of translation is essentially a form of art, not of a technology, in that translation is often divergent from the original, with a deviation, which, cumulatively, often renders the translation useless.

The embodiments provided below address the above identified issues and needs.

### SUMMARY OF THE INVENTION

In one aspect of the present invention, it is provided a social safe method of language translation, comprising:

a) inputting a sentence, a phrase, a paragraph, or an article of an original language as an original language input (“OLI”),

b) translating the OLI to a sentence, a phrase, a paragraph, or an article of a target language of translation as a version of translation (“TLVx”) using a language translation platform,

c) translating the TLVx to a sentence, a phrase, a paragraph, or an article of the original language using the language translation platform (“TLVOx”),

d) comparing the TLVOx with OLI to generate a translation accuracy index (“TAINDx”),

e) discarding the TLVOx if TAIND has a value less than a threshold value set by a user TAINDo,

f) repeating steps b)-e) until the TAINDx is not less than TAINDo and then designating the corresponding TLVx as target language output (“TLO”), and

g) outputting the TLO.

In some embodiments, optionally in combination with the various embodiments of invention method disclosed herein, the original language is English and the target language of translation is Chinese or vice versa.

In some embodiments, optionally in combination with the various embodiments of invention method disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention method disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention method disclosed herein, the TAINDo is 1.

In some embodiments, optionally in combination with the various embodiments of invention method disclosed herein, the TAINDo is 0.8 or higher.

In some embodiments, optionally in combination with the various embodiments of invention method disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention method disclosed herein, the inputting is by text input, voice input, or machine reading.

In some embodiments, optionally in combination with the various embodiments of invention method disclosed herein, the outputting is by text output, voice output, or machine printing.

In some embodiments, optionally in combination with the various embodiments of invention method disclosed herein, the OLI and TLO are medicinal terms concerning a COVID-19 disease.

In another aspect of the present invention, it is provided a social safe device comprising a software program, the software program comprising:

Module 100 for a) inputting a sentence, a phrase, a paragraph, or an article of an original language as an original language input (“OLI”),

Module 200 for b) translating the OLI to a sentence, a phrase, a paragraph, or an article of a target language of translation as a version of translation (“TLVx”) using a language translation platform and c) translating the TLVx to a sentence, a phrase, a paragraph, or an article of the original language using the language translation platform (“TLVOx”),

Module 300 for d) comparing the TLVOx with OLI to generate a translation accuracy index (“TAINDx”), e) discarding the TLVOx if TAIND has a value less than a threshold value set by a user TAINDo, and f) causing Module 200 to repeat steps b)-e) until the TAINDx is not less than TAINDo and then designating the corresponding TLVx as target language output (“TLO”), and

Module 400 for g) outputting the TLO.

In some embodiments, optionally in combination with the various embodiments of invention device disclosed herein, the original language is English and the target language of translation is Chinese or vice versa.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the TAINDo is 1.

In some embodiments, optionally in combination with the various embodiments of invention device disclosed herein, the TAINDo is 0.8 or higher.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention device disclosed herein, the inputting is by text input, voice input, or machine reading.

In some embodiments, optionally in combination with the various embodiments of invention device disclosed herein, the outputting is by text output, voice output, or machine printing.

In a further aspect of the present invention, it is provided a device comprising the software program, the software program comprising:

Module 100 for a) inputting a sentence, a phrase, a paragraph, or an article of an original language as an original language input (“OLT”),

Module 200 for b) translating the OLI to a sentence, a phrase, a paragraph, or an article of a target language of translation as a version of translation (“TLVx”) using a language translation platform and c) translating the TLVx to a sentence, a phrase, a paragraph, or an article of the original language using the language translation platform (“TLVOx”),

Module 300 for d) comparing the TLVOx with OLI to generate a translation accuracy index (“TAINDx”), e) discarding the TLVOx if TAIND has a value less than a threshold value set by a user TAINDo, and f) causing Module 200 to repeat steps b)-e) until the TAINDx is not less than TAINDo and then designating the corresponding TLVx as target language output (“TLO”), and

Module 400 for g) outputting the TLO.

In some embodiments, optionally in combination with the various embodiments of invention device disclosed herein, the original language is English and the target language of translation is Chinese or vice versa.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the TAINDo is 1.

In some embodiments, optionally in combination with the various embodiments of invention device disclosed herein, the TAINDo is 0.8 or higher.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention device disclosed herein, the inputting is by text input, voice input, or machine reading.

In some embodiments, optionally in combination with the various embodiments of invention device disclosed herein, the outputting is by text output, voice output, or machine printing.

In some embodiments, optionally in combination with the various embodiments of invention device disclosed herein, the device is a portable device such as a smart phone or a wearable device.

### BRIEF DESCRIPTION OF THE DRAWINGS

FIG. 1 shows a flow chart of an embodiment of the invention method.

FIG. 2 illustrates components of an embodiment software program of invention.

### DETAILED DESCRIPTION OF THE INVENTION

### Definitions

As used herein, unless otherwise specified, the term “convergent” or “converge” shall mean using the original language input as a point of check. In a method of convergent translation, versions of target language of translation are translated back to versions of (“back translated versions”) of the original language of input, the back translated versions are compared with the original language input. A version of target language of translation is discarded if comparison of the corresponding back translated version with the original language input yields a degree of accuracy that does not meet a value set by a user of the method of invention. More detailed description of the method of convergent translation is provided below.

As used herein, unless otherwise specified, the term “language translation platform” shall mean any language translator software that is commercially available. An example of such “language translation platform” is the Google Translate platform.

As used herein, unless otherwise specified, the term “input” shall mean input of an original language for translation, and the term “original language” shall mean the language that is submitted for translation. In this context, unless otherwise specified, the term “target language” or “target language of translation” shall mean the language that a user intends the input of original language to be translated to so as to produce a translation output or translation product of target language. Further in this context, unless otherwise specified, the term “back translation” or “back translated” shall mean submitting the “translation output” or “translation product” to translation back to a version of original language. The example below further illustrates these definitions.

For example, if a user intends to translation a sentence of English to a sentence of Chinese, English is the original language, Chinese is the target language or target language of translation, the sentence of English is an input of original language or original input, and the sentence of Chinese is a translation output or translation product. Back translation occurs when the sentence of Chinese, which is the translation output or translation product, is translated back to a sentence of English—the input of original language—which may be the same as or different than the original input and is used to generate an accuracy index of translation, which is explained described in detail below.

### Convergent Translation

Convergent translation is a method that uses the original language input as a gate keeper or check point and versions of translation product of target language are translated back to the original language to be compared with, improved upon converge toward. In one aspect of the present invention, it is provided a method of language translation, comprising:

a) inputting a sentence, a phrase, a paragraph, or an article of an original language as an original language input (“OLI”),

b) translating the OLI to a sentence, a phrase, a paragraph, or an article of a target language of translation as a version of translation (“TLVx”) using a language translation platform,

c) translating the TLVx to a sentence, a phrase, a paragraph, or an article of the original language using the language translation platform (“TLVOx”),

d) comparing the TLVOx with OLI to generate a translation accuracy index (“TAINDx”),

e) discarding the TLVOx if TAIND has a value less than a threshold value set by a user TAINDo,

f) repeating steps b)-e) until the TAINDx is not less than TAINDo and then designating the corresponding TLVx as target language output (“TLO”), and

g) outputting the TLO.

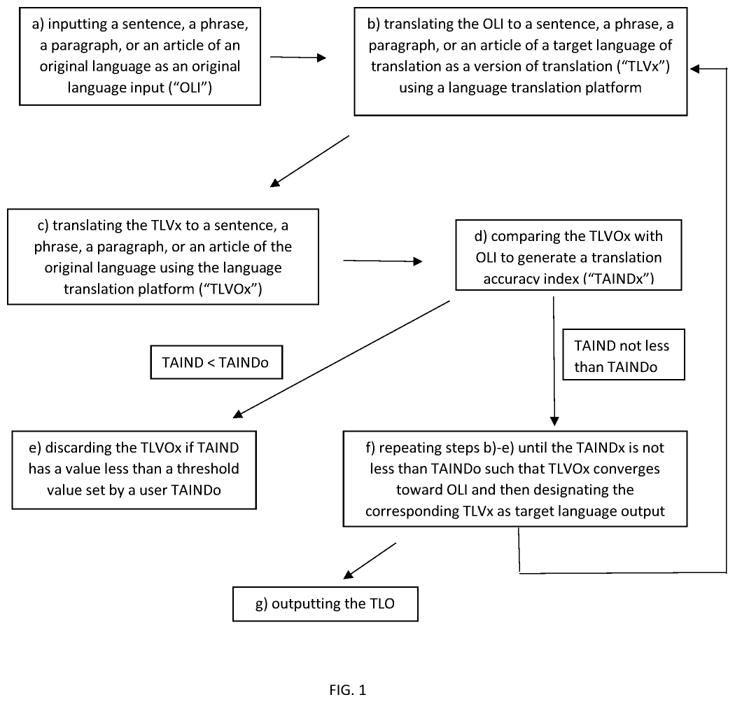

A flow chart that shows an embodiment of the invention method is shown in FIG. 1.

In some embodiments, optionally in combination with the various embodiments of invention method disclosed herein, the original language is English and the target language of translation is Chinese or vice versa.

In some embodiments, optionally in combination with the various embodiments of invention method disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention method disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention method disclosed herein, the TAINDo is 1.

In some embodiments, optionally in combination with the various embodiments of invention method disclosed herein, the TAINDo is 0.8 or higher.

In some embodiments, optionally in combination with the various embodiments of invention method disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention method disclosed herein, the inputting is by text input, voice input, or machine reading.

In some embodiments, optionally in combination with the various embodiments of invention method disclosed herein, the outputting is by text output, voice output, or machine printing.

In some embodiments, optionally in combination with the various embodiments of invention method disclosed herein, the OLI and TLO are medicinal terms concerning a COVID-19 disease.

The language translation platform can be any language translator available in digital form or online, e.g., language translators commonly adopted and used by internet service providers. One example of such translator is Google Translate.

### Language Translation and Accuracy Index

Language translation is an art of long history, dating back to the early years of human activity. In modern times, translation is generally achieved using a multilingual dictionary. In the digital era, a digital translator often by-and-large involves a database where dictionaries of multiple languages and fields of arts are stored and archived, and when an input of an original language is made, a target language translation command is triggered to cause the translator to process the input of original language to output a translation product of the target language.

It is true that language translation is complicated by a variety of factors, which mainly include: variation of meaning of a word or phrase in an input of original language, variation of meaning of a corresponding word or phrase in the target language of translation, grammatic variations, context, field of art variations, and social, economic, and historical context and backgrounds. However, such various layers of variations are largely contained by the common use of multiple language dictionaries, which are common and available, and grammatic rules. Additionally, the ever-evolving computing speed/capacity of computers and devices (portable devices such as a smart phone and wearable devices such as Apple watch) makes possible to run many cycles of translation within a unit of time, e.g., a second or seconds. As such, a try-and-error approach, guided by an accuracy index threshold set by a user, using the input of original language as the convergent point, readily allows a translator to produce a translation product that improves and converges toward the accuracy index threshold.

Accuracy index of translation is a way to define translation quality. It is defined to have a value from 0 to 1, where 0 represents zero fidelity in the translation product, and 1 represents 100% fidelity in the translation product. Accuracy index can be defined by the following equation:

TAIND=Number of words of match of the translation product,back translated to the original language of input/Number of words of input of original language

In the above equation, the term words shall include sentence separation or punctuation symbols such as “,”, “.”, etc. In this context, the term match shall mean same word and same grammatic arrangement. Words that fall out of this definition are termed as “mismatch”.

In some embodiments, the term mismatch can mean a different word having the same meaning as the translation input of original language. In some further embodiments, the term match can mean a different word having a meaning that is similar with that of the translation input of original language.

It is important to note that a “match” of same word and of same grammatic arrangement is generally applicable to and required by translations of mathematics, scientific and technological fields, legal fields, and official documents. Additionally, as translation is confined by meanings of words and grammatic rules in the input of original language and in the target language of translation, irrelevant words are excluded from the translation product. This is evidenced and shown by the existing translation platforms, e.g., Google Translate.

As such, a mismatch word, as described herein, could still be used or contained in a translation product of the invention method. For example, a “mismatch” of a word of same meaning and of same grammatic arrangement or a “mismatch” of a word of similar meaning and of same grammatic arrangement are generally applicable to and required by translations in fields other than mathematics, scientific and technological fields, legal fields, and official documents, e.g., articles in social and liberal arts, and literary arts.

As a mismatch word is excluded from the accuracy index equation, the accuracy index of translation has a value that is either 1 or below 1, with zero being the extreme. An index value above 0 would indicate at least one word, one phrase, or one sentence in a translation product, when translated back to the original language of translation input, is identical to the corresponding one word, one phrase, or one sentence in the input of original language.

Further, the convergent method of translation of invention can be designed to translate the input step by step, e.g., to translate that starts from a word, then a phrase, and then a sentence, each step can have individual accuracy check using an accuracy index threshold input set by a user. As such, the translation product by the invention method can readily achieve an accuracy index having a value that is 1, which is 100% fidelity to the input of original language.

### Social Safe Device

In another aspect of the present invention, it is provided a social safe device having a software program, the software program comprising:

Module 100 for a) inputting a sentence, a phrase, a paragraph, or an article of an original language as an original language input (“OLT”),

Module 200 for b) translating the OLI to a sentence, a phrase, a paragraph, or an article of a target language of translation as a version of translation (“TLVx”) using a language translation platform and c) translating the TLVx to a sentence, a phrase, a paragraph, or an article of the original language using the language translation platform (“TLVOx”),

Module 300 for d) comparing the TLVOx with OLI to generate a translation accuracy index (“TAINDx”), e) discarding the TLVOx if TAIND has a value less than a threshold value set by a user TAINDo, and f) causing Module 200 to repeat steps b)-e) until the TAINDx is not less than TAINDo and then designating the corresponding TLVx as target language output (“TLO”), and

Module 400 for g) outputting the TLO.

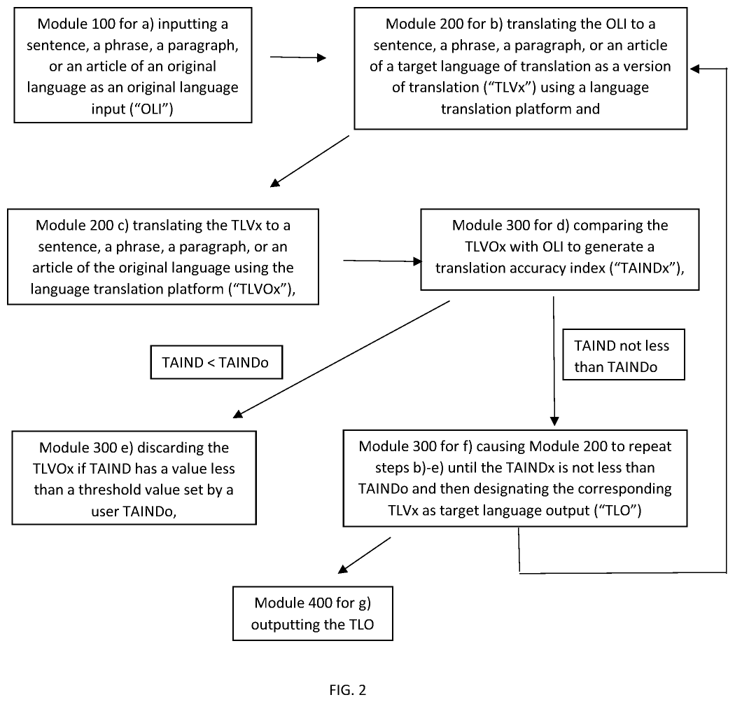

An embodiment of the software program of invention is shown in FIG. 2.

In some embodiments, optionally in combination with the various embodiments of invention device disclosed herein, the original language is English and the target language of translation is Chinese or vice versa.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the TAINDo is 1.

In some embodiments, optionally in combination with the various embodiments of invention device disclosed herein, the TAINDo is 0.8 or higher.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention device disclosed herein, the inputting is by text input, voice input, or machine reading.

In some embodiments, optionally in combination with the various embodiments of invention device disclosed herein, the outputting is by text output, voice output, or machine printing.

### Social Safe Translation System

In a further aspect of the present invention, it is provided a social safe system comprising a device comprising a software program, the software program comprising:

Module 100 for a) inputting a sentence, a phrase, a paragraph, or an article of an original language as an original language input (“OLT”),

Module 200 for b) translating the OLI to a sentence, a phrase, a paragraph, or an article of a target language of translation as a version of translation (“TLVx”) using a language translation platform and c) translating the TLVx to a sentence, a phrase, a paragraph, or an article of the original language using the language translation platform (“TLVOx”),

Module 300 for d) comparing the TLVOx with OLI to generate a translation accuracy index (“TAINDx”), e) discarding the TLVOx if TAIND has a value less than a threshold value set by a user TAINDo, and f) causing Module 200 to repeat steps b)-e) until the TAINDx is not less than TAINDo and then designating the corresponding TLVx as target language output (“TLO”), and

Module 400 for g) outputting the TLO.

In some embodiments, optionally in combination with the various embodiments of invention device disclosed herein, the original language is English and the target language of translation is Chinese or vice versa.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

In some embodiments, optionally in combination with the various embodiments of invention device disclosed herein, the TAINDo is 1.

In some embodiments, optionally in combination with the various embodiments of invention device disclosed herein, the TAINDo is 0.8 or higher.

In some embodiments, optionally in combination with the various embodiments of invention device disclosed herein, the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and the target language of translation is one of English, Chinese, Japanese, Korean, Russian, Afghanistan, Persian, Hebrew, German, French, Italian, Spanish, Portuguese, and Arabic.

In some embodiments, optionally in combination with the various embodiments of invention device disclosed herein, the inputting is by text input, voice input, or machine reading.

In some embodiments, optionally in combination with the various embodiments of invention device disclosed herein, the outputting is by text output, voice output, or machine printing.

In some embodiments, optionally in combination with the various embodiments of invention device disclosed herein, the device is a portable device such as a smart phone or a wearable device. The system can be any system of devices or computers or other device or machines capable of data transmission.

It is understood that the foregoing detailed description and the following examples are illustrative only and are not to be taken as limitations upon the scope of the invention. Various changes and modifications to the disclosed embodiments, which will be apparent to those of skill in the art, may be made without departing from the spirit and scope of the present invention. Further, all patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents are based on the information available to the applicants and do not constitute any admission as to the correctness of the dates or contents of these documents.

The following examples illustrate rather than limit the embodiments of the present invention.

### EXAMPLES

Example 1: Translation of an English sentence to Chinese using Google Translate Original Language Input (“OLI”) (English)—This man is an honorable man. You can trust him. Target Language Translation (“TLV1”) (Chinese)—Zhège rén shì guāngróng de rén. N\check{i} kěy\check{i} xiāngxìn tā ( [symbol] [symbol] ).

Translation of TLV1 back to the Original language (“TLVO1”) This person is a glorious person.
You can believe him.
Match words: 6,
Mismatch words: 4
Translation accuracy index (“TAIND1”): match words/OLI=6/10=0.60.
Target Language Translation (“TLV2”) (Chinese)—Zhège nánrén shìge kěkào de nánrén. N\check{i} kěy\check{i} xìnlài tā ( [symbol] [symbol] [symbol] ).
Translation of TLV2 back to the Original language (“TLVO2”)—This man is a reliable man. You can trust him.
Match words: 9,
Mismatch word: 1
Translation accuracy index (“TAIND2”): match words/Oil 9/10 0.90,
Comparison: TLV2—Zhège nánrén shìge kěkào de nánrén. N\check{i} kěy\check{i} xìnlài tā [symbol] [symbol] [symbol] )—is a more accurate Chinese translation of the—This man is an honorable man. You can trust him.
Translation output (“TLO”)—Zhège nánrén shìge kěkào de nánrén. N\check{i} kěy\check{i} xìnlài tā ( [symbol] [symbol] [symbol] [symbol] ).

Example 2. Translation of a Chinese sentence to English using Google Translate Original Language Input (“OLI”) (Chinese)—Zhège b\check{a}ojiàn p\check{i}n zhēn de duí n\check{i} hěn y\check{o}uyòng. H\check{a}oh\check{a}o yóng ( [symbol] [symbol] [symbol] )

Target Language Translation (“TLV1”) (English)—This health supplement is really useful you. Use it well.
Translation of TLV1 back to the Original language (“TLVO1”)— [symbol] [symbol] [symbol] .
Match words: 11,
Mismatch words: 4
Translation accuracy index (“TAIND1”): match words/OLI=11/15=0.73.
Target Language Translation (“TLV2”) (English)—This dietary supplement is really good for you. Use it well.
Translation of TLV2 back to the Original language (“TLVO2”)—Zhè zh\check{o}ng b\check{a}ojiàn p\check{i}n quèshí duì ní y\check{o}uyì. H\check{a}oh\check{a}o yòng ( [symbol] [symbol] [symbol] ).
Match words: 14.
Mismatch word: 1
Translation accuracy index (“TAIND2”): match words/OLI=14/15=0.93.
Comparison: TLV2—This dietary supplement is really good for you. Use it well.—is a more accurate Chinese translation of the OLI—Zhége b\check{a}ojián p\check{i}n zhēn de duì n\check{i} hěn y\check{o}uy\check{o}ng. H\check{a}oh\check{a}o yòng ( [symbol] [symbol] [symbol] ).
Translation output (“ILO”)—This dietary supplement is really good for you. Use it well.

Those skilled in the art will know, or be able to ascertain, using no more than routine experimentation, many equivalents to the specific embodiments of the invention described herein. These and all other equivalents are intended to be encompassed by the following claims.

I claim:

1. A social safe method of language translation, comprising:
a) inputting a sentence, a phrase, a paragraph, or an article of an original language as an original language input (“OLI”),
b) translating the OLI to a sentence, a phrase, a paragraph, or an article of a target language of translation as a version of translation (“TLVx”) using a language translation platform,
c) translating the TLVx to a sentence, a phrase, a paragraph, or an article of the original language using the language translation platform (“TLVOx”),
d) comparing the TLVOx with OLI to generate a translation accuracy index (“TAINDx”),
e) discarding the TLVOx if TAIND has a value less than a threshold value set by a user TAINDo,
f) repeating steps b)-e) until the TAINDx is not less than TAINDo such that TLVOx converges toward OLI and then designating the corresponding TLVx as target language output (“TLO”),
g) outputting the TLO.

2. The method according to claim 1, wherein the original language is English and the target language of translation is Chinese or vice versa.

3. The method according to claim 1, wherein the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

4. The method according to claim 1, wherein the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

5. The method according to claim 1, wherein the TAINDo is 1.

6. The method according to claim 1, wherein the TAINDo is 0.8 or higher.

7. The method according to claim 1, wherein the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and
wherein the target language of translation is one of English, Chinese, Japanese, Korean, Russian, Afghanistan, Persian, Hebrew, German, French, Italian, Spanish, Portuguese, and Arabic.

8. The method according to claim 1, wherein the inputting is by text input, voice input, or machine reading.

9. The method according to claim 1, wherein the outputting is by text output, voice output, or machine printing.

10. The method according to claim 1, wherein the OLI and TLO are medicinal terms concerning a COVID-19 disease.

11. A social safe device having a software program, the software program comprising:
Module 100 for a) inputting a sentence, a phrase, a paragraph, or an article of an original language as an original language input (“OLI”),
Module 200 for b) translating the OLI to a sentence, a phrase, a paragraph, or an article of a target language of translation as a version of translation (“TLVx”) using a language translation platform and c) translating the TLVx to a sentence, a phrase, a paragraph, or an article of the original language using the language translation platform (“TLVOx”),
Module 300 for d) comparing the TLVOx with OLI to generate a translation accuracy index (“TAINDx”), e) discarding the TLVOx if TAIND has a value less than a threshold value set by a user TAINDo, and f) causing Module 200 to repeat steps b)-e) until the TAINDx is not less than TAINDo and then designating the corresponding TLVx as target language output (“TLO”), and
Module 400 for g) outputting the TLO.

12. The device according to claim 11, wherein the original language is English and the target language of translation is Chinese or vice versa.

13. The device according to claim 11, wherein the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

14. The device according to claim 11, wherein the target language of translation is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian.

15. The device according to claim 11, wherein the TAINDo is 1.

16. The device according to claim 11, wherein the TAINDo is 0.8 or higher.

17. The device according to claim 11, wherein the original language is one of English, Chinese, Japanese, Korean, Russian, Afghanistan, Persian, Hebrew, German, French, Italian, Norwegian, Danish, Finnish, Spanish, Portuguese, Arabic, Indonesian, and Malaysian; and
wherein the target language of translation is one of English, Chinese, Japanese, Korean, Russian, Afghanistan, Persian, Hebrew, German, French, Italian, Spanish, Portuguese, and Arabic.

18. The device software program according to claim 11, wherein the inputting is by text input, voice input, or machine reading.

19. The device software program according to claim 11, wherein the outputting is by text output, voice output, or machine printing.

20. A social safe system comprising a device according to claim 11.
